(19) United States
(12) Patent Application Publication
(10) Pub. No.: US 2018/0103141 A1
(43) Pub. Date: Apr. 12, 2018

(54) TEXTING SAFETY SYSTEM

(71) Applicant: Demetrius Thompson, Woodland Hills, CA (US)

(72) Inventor: Demetrius Thompson, Woodland Hills, CA (US)

(21) Appl. No.: 15/287,128

(22) Filed: Oct. 6, 2016

(51) Int. Cl. H04M 1/725; H04W 4/14

(52) U.S. Cl. CPC H04M 1/72577; H04W 4/14

(57) ABSTRACT

A method for providing safety when a text messages is received on a device capable of receiving a text message and displaying the text message on a screen while in a moving vehicle, comprising determining whether a text message is received on the device. If a text message is received, determining if the vehicle is moving. If the vehicle is not moving, then the received message is displayed. If the vehicle is determined to be moving more than a predetermined speed, then the screen of the cell phone is blackened or blanked until it is determined that the vehicle is no longer moving. Upon determining that the vehicle in no longer moving, then the received message is displayed.

### FIELD OF THE INVENTION

The present invention is in the field of mobile telephones and more specifically to a system for providing safety when attempting to read text messages.

### BACKGROUND OF THE INVENTION

Mobile telephones (cell phones) and their use in cars have become pervasive. Cellular phone text messaging, referred to in the industry as short message service (“SMS”), is particularly dangerous while driving. There are numerous reports of deadly accidents occurring while the driver was responding to a text message. In recent years, some cities have put restrictions on the use of cell phones while driving, such as requiring drivers to use an ear bud or a hands-free phone, hut these laws do not address what a driver does when receiving a text message. The urge to respond is very strong, so that just receiving a text message often results in texting a response notwithstanding that the person sending the text response is driving. On the other hand, if the person receiving the text message is just a passenger, there is no need to be concerned.

The cellular telephone system is a technological wonder, and a number of driving-related enhancements to that system have been proposed. WO 96/01531 uses the cellular telephone system to determine the location and speed of a vehicle carrying an active cellular telephone. It is proposed that this system be used for an automatic parking system (to record the presence of a vehicle in a parking slot & charge for that parking, etc.), as a speed radar system that could automatically charge speeding violations to a user's telephone bill or as a theft deterrent to locate stolen vehicles. WO 98/16077, WO 98/25158 and WO 98/59256 disclose the use of a GPS (Global Positioning System) receiver in conjunction with a cellular network to derive similar information.

Japanese laid-open patent application F110-42371 deals with another aspect of the problem of driving while phoning. That application discloses a vehicle mounted unit that jams any cellular signals while the car is in operation. Of course, this makes the reception of important calls impossible. U.S. Pat. No. 6,262,657 to Okuda et al. obviates some of these problems by automatically issuing a driver alert (received over the telephone) when driving characteristics become erratic while a cellular phone is being used. However, both of these solutions require a separate unit mounted in the vehicle. Thus, a user is not protected in rental cars or cars other than his or her usual vehicle.

Two patents have issued to the inventor, U.S. Pat. Nos. 7,308,247 and 7,986,934, both titled “Cellular telephone safety system,” to deal with drivers who are distracted by talking on a cell phone while driving. The system described by these patents is known as Global Mobile Alert (“GMA”)) and provides a method for improving safety in using a wireless communication device, such as a cell phone, and which is capable of receiving a GPS signal that includes GPS coordinates of a plurality of traffic lights. The GPS is queried to obtain a current location for the cell phone in the form of geographical coordinates, which is periodically updated. The geographical coordinates of the then current location is compared to the geographical coordinates of the closest traffic light to determine when the then current location is within a predetermined distance from it, whereby an audible alarm is issued if the vehicle is moving and the cell phone is in an active voice mode wherein a person can speak through the device. The disclosures of U.S. Pat. Nos. 7,308,247 and 7,986,934 are hereby incorporated by reference.

### BRIEF SUMMARY OF THE INVENTION

The present invention provides a method for providing safety when attempting to text a message. It finds use with the aforementioned GMA, but can be used as a stand-alone application. When an SMS is received and the GMA or any text messaging cell phone or other such device is active, the speed of the vehicle is determined. If it is greater than a predetermined amount, say 5 miles per hour (or in other embodiments if any movement of the vehicle is detected), then the screen of the cell phone goes black or blank and the sound function of the cell phone is muted. This is maintained as long as the vehicle is moving and until the vehicle is no longer moving. When the vehicle is stopped, a message on the cell phone warning against texting while driving, such as “Pull Over To Text” is then displayed for a short period of time, say from three to fifteen, preferably about five seconds, following which the received text message is displayed and can be answered. In a further embodiment, when the “Pull Over To Text” or other warning message is displayed, an automatic response can be sent to the sender of the text message, such as “Sorry I was unable to answer your text,” I will call in a few minutes,” “I will text you back in a few minutes,” “I will text you when I pull over,” or other appropriate message. The application can provide an input that will allow a responding message to be created or to be selected from a menu of messages, or to turn off a selected responding message.

### BRIEF DESCRIPTION OF THE DRAWINGS

For a more complete understanding of the present invention, reference is now made to the following descriptions taken in conjunction with the accompanying drawing, in which:

FIG. 1 is the “Pull Over To Text” message displayed on the screen of the cell phone when an SMS is received; and

FIG. 2 is a flow chart of a method for determining whether a text message is being received and, if so, blacking or blanking the cell phone screen until the vehicle is stopped.

### DETAILED DESCRIPTION OF THE INVENTION

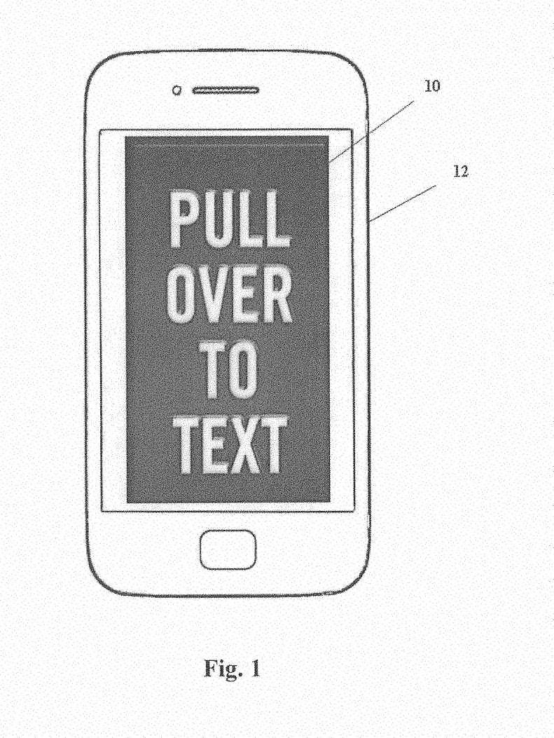

Referring to FIG. 1, a “Pull Over To Text” message 10 is displayed when an SMS is received under certain conditions (as described below) as shown on a schematic representation of any device 12 capable of receiving an SMS, whether built-in or capable of downloading a computer program application (“app”), for example a cell phone such as an Apple iPhone, an Android Smartphone, a Blackberry Smartphone, a Windows Smartphone, a Symbian Smartphone, or the like. Of course, one could choose to display any other message, such as “Texting While Driving is Illegal” (if true) as determined by the programmer.

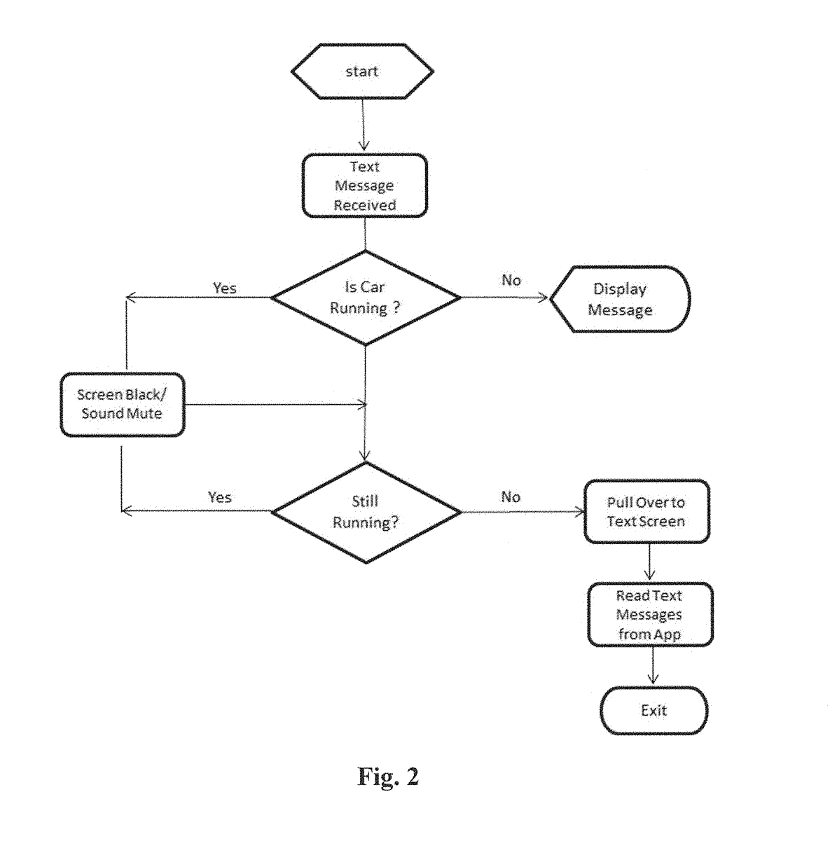

FIG. 2 is a flow chart of a method for determining whether a text message is being received and, if so, blackening of blanking the screen until the vehicle stops, displaying the “Pull Over To Text” message of FIG. 1 for a short period of time, then allowing the received text message to be read and responded to. In this embodiment the method is performed as part of the GMA referred to above, but can be a standalone program, or part of an app different from the GMA app, or built into the device such part of a GPS system of built in car phone. At its start, when a text message is received, the program determines if the vehicle is moving. If it is not, then the received message is displayed and can be responded to. If the vehicle is found to be moving, then the screen of the cell phone is blackened or blanked. The program makes an inquiry as to Whether the vehicle is still moving. If yes then the screen is maintained as blackened or blanked and any sound is muted. This cycle repeats until the answer to the “Still moving” query is no whereupon the warning of FIG. 1 is displayed for the afore-described short period of time. The received message is then displayed on the cell phone screen and can be responded to, whereupon the program exits until a new text message is received.

In a further embodiment, when the “Pull Over To Text” message 26 is displayed, an automatic response can be sent to the sender of the text message, such as “Sorry I was unable to answer your text,” I will call in a few minutes,” “I will text you back in a few minutes,” “I will text you when I pull over,” or other appropriate message. The application can provide an input that will allow a message to be created or to be selected from a menu of messages, or to turn off a selected message.

Although the present invention has been described in, connection with the preferred embodiments, it is to be understood that modifications and variations may be utilized without departing from the principles and scope of the invention, as those skilled in the art will readily understand. Accordingly, such modifications may be practiced within the scope of the following claims.

1. A method for providing safety when a text messages is received on a device capable of receiving a text message and displaying the text message on a screen while in a moving vehicle, comprising:
(a) determining whether a text message is received on the device;
(b) if a text message is received, determining if the vehicle is moving;
(c) if the vehicle is not moving, then the received message is displayed;
(d) if any movement of the vehicle is detected, then the screen of the device immediately goes black or blank until it is determined that the vehicle is no longer moving; and
(e) upon determining that the vehicle in no longer moving, then the received message is displayed.

2. The method of claim 1 wherein the step of determining if the vehicle is moving comprises determining if the vehicle is moving at a speed greater than a predetermined speed.

3. The method of claim 1 wherein when the vehicle is determined to no longer be moving, prior to displaying the received message, a warning message is displayed for a period of time.

4. The method of claim 3 wherein the warning message is the text “Pull Over To Text.”

5. The method of claim 3 wherein when the warning message is displayed, an automatic response is sent to the sender of the text message.

6. The method of claim 5 wherein the warning message is selectable from a menu of messages.

7. The method of claim 1 wherein the device is a cell phone.

8. The method of claim 1 wherein the device has a sound function which is muted when the screen of the device is blackened or blanked.
